(19) United States
(12) Patent Application Publication
(10) Pub. No.: US 2007/0071416 A1
(43) Pub. Date: Mar. 29, 2007

(54) Image management apparatus and method

(75) Inventor: Kenji Ikemizu, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/333,255

(22) Filed: Jan. 18, 2006

(30) Foreign Application Priority Data
Jan. 19, 2005 (JP) 2005-011806

(51) Int. Cl. H04N 5/00

(52) U.S. Cl. 386/117

(57) ABSTRACT

An image management apparatus, comprising: an image capture device which captures images; an image saving device which saves the images; a user identification information reading device which contactlessly reads user identification information from a contactless IC card containing the user identification information unique to a given user; a folder creating device which automatically creates in the image saving device an image folder unique to the user when the user identification information reading device reads user identification information and if there is no image folder unique to the user corresponding to the read user identification information; an image storage control device which stores any image captured via the image capture device in the image folder corresponding to the read user identification information after the user identification information is read by the user identification information reading device; and an image output control device which makes any image stored in the image folder corresponding to the read user identification information ready for output when the user identification information is read by the user identification information reading device.

### BACKGROUND OF THE INVENTION

1. Field of the Invention

The present invention relates to an image management apparatus and method. More particularly, it relates to a technique for user-by-user management of images saved in an image management apparatus shared by multiple people.

2. Description of the Related Art

When sharing a personal storage (hard disk drive or the like in a personal computer), which contains private data such as images shot by a digital camera or other apparatus among multiple people such as family members, some mechanism is needed to prevent the private data from being viewed by others.

There is no problem if an operating system (OS) controls to what extent each user is allowed to use the machine, as in the case of a personal computer. However, recent HDD/DVD recorders and the like which do not manage users are capable of storing images shot by digital cameras, allowing anyone to view the images.

Conventional methods for managing saved image files include a method which manages access by classifying storage areas using unique identification information recorded on a recording medium such as a memory card (Japanese Patent Application Laid-Open No. 2001-144921).

Also, methods for portable terminals include a method which manages access by classifying storage areas on the terminals using identification information (subscriber information) recorded on a removable recording medium (e.g., an IC card) such as an SIM card (Subscriber Identity Module Card) (Japanese Patent Application Laid-Open No. 2004-336719).

The method disclosed in Japanese Patent Application Laid-Open No. 2001-144921 is not applicable to situations in which multiple people use the same recording medium while generally the same digital camera and recording medium are used in a family.

On the other hand, the method disclosed in Japanese Patent Application Laid-Open No. 2004-336719 has a problem in that removable recording media can be used only on certain apparatus (e.g., the SIM card can be used only on limited types of cell phones), and cannot be used on other apparatus.

### SUMMARY OF THE INVENTION

The present invention has been made in view of the above circumstances and has an object to provide an image management apparatus and method which make it possible to easily manage private images of multiple users by simple manipulation and restrict others from accessing the images.

To achieve the above object, according to a first aspect of the present invention, there is provided an image management apparatus, comprising: an image capture device which captures images; an image saving device which saves the images; a user identification information reading device which contactlessly reads user identification information from a contactless IC card containing the user identification information unique to a given user; a folder creating device which automatically creates in the image saving device an image folder unique to the user when the user identification information reading device reads user identification information and if there is no image folder unique to the user corresponding to the read user identification information; an image storage control device which stores any image captured via the image capture device in the image folder corresponding to the read user identification information after the user identification information is read by the user identification information reading device; and an image output control device which makes any image stored in the image folder corresponding to the read user identification information ready for output when the user identification information is read by the user identification information reading device.

The image management apparatus according to the present invention, which can be shared by family members, can store images of each user in an image folder unique to the user with user's simple manipulation. It prevents private images from being viewed by others. Also, by reading user identification information from a contactless IC card carried by each user when registering and viewing the image, it functions as a machine dedicated to the currently-logged user from login to logout and power-off. Specifically, after reading user identification information from a contactless IC card owned by a give user, the image management apparatus automatically creates an image folder unique to the user corresponding to the read user identification information if no such folder exists yet and allows images to be stored in the image folder or outputted from the image folder (to a display device for viewing or to a printer). Thus, no user can access the image folder of another user unless the user uses the contactless IC card of the other user. This prevents private images from being viewed by others.

According to a second aspect, in the image management apparatus according to the first aspect, the image capture device comprises at least one of a communications device which captures images by wire or radio, an image reading device which reads images from a recording medium containing images, and an image pickup device which picks up and captures images.

According to a third aspect, in the image management apparatus according to the first aspect, the contactless IC card can be a contactless IC card incorporated in a user's portable apparatus.

According to a fourth aspect, the image management apparatus according to the first aspect further comprises a cryptographic key generating device which generates a cryptographic key from the user identification information read by the user identification information reading device, wherein the image storage control device encrypts the images captured via the image capture device based on the cryptographic key generated by the cryptographic key generating device and stores the images in the appropriate image folder. Since the images stored in the image folders of respective users are encrypted by the cryptographic key generated from the-read user identification information, it is possible to enhance security.

According to a fifth aspect, the image management apparatus according to the fourth aspect further comprises a decryption key generating device which generates a decryption key from the user identification information read by the user identification information reading device, wherein the image output control device decrypts the encrypted images stored in the image folder corresponding to the user identification information based on the decryption key generated by the decryption key generating device and makes the decrypted images ready for output. A decryption key is generated based on the read user identification information to decrypt the encrypted image in each image folder. Incidentally, the decryption key generating device may be identical to the cryptographic key generating device according to the fourth aspect. In that case, the decryption key is identical to the cryptographic key.

According to a sixth aspect, there is provided an image management method, comprising the steps of: contactlessly reading user identification information from a contactless IC card containing the user identification information unique to a given user; determining whether an image folder unique to the user corresponding to the read user identification information exists in an image saving device and automatically creating an image folder unique to the user corresponding to the user identification information if no such image folder exists; storing images captured via an image capture device in the image folder unique to the user corresponding to the read user identification information when storing the captured images in the image saving device; and outputting images from the image folder unique to the user corresponding to the read user identification information when outputting saved images from the image saving device.

According to a seventh aspect, in the image management method according to the sixth aspect, in the step of storing captured images in the image folder unique to the user corresponding to the read user identification information a cryptographic key based on the read user identification information is created and stores the image after encrypting the image based on the cryptographic key.

According to an eighth aspect, in the image management method according to the seventh aspect, in the step of outputting images from the image folder a decryption key based on the read user identification information read by the user identification information reading device is generated, the encrypted images stored in the image folder based on the decryption key is decrypted, and the decrypted image is outputted.

The present invention makes it possible to easily manage private images of multiple users easily by simply reading user identification information from a user-specific contactless IC card carried by each user, and thereby restrict others from accessing the images.

### BRIEF DESCRIPTION OF THE DRAWINGS

FIG. 1 is an external view of an image management apparatus according to an embodiment of the present invention;

FIG. 2 is a block diagram showing an internal configuration of an image management apparatus;

FIG. 3 is a flowchart of an image capture process on the image management apparatus;

FIG. 4 is a diagram showing an example of a user management table;

FIG. 5 is a diagram showing a folder tree structure on a hard disk;

FIG. 6 is a flowchart of an image viewing process on the image management apparatus; and

FIGS. 7A, 7B, and 7C are diagrams illustrating procedures for displaying a desired image when viewing images.

### DETAILED DESCRIPTION OF THE PREFERRED EMBODIMENTS

An image management apparatus and method according to a preferred embodiment of the present invention will be described in detail below with reference to the attached drawings.

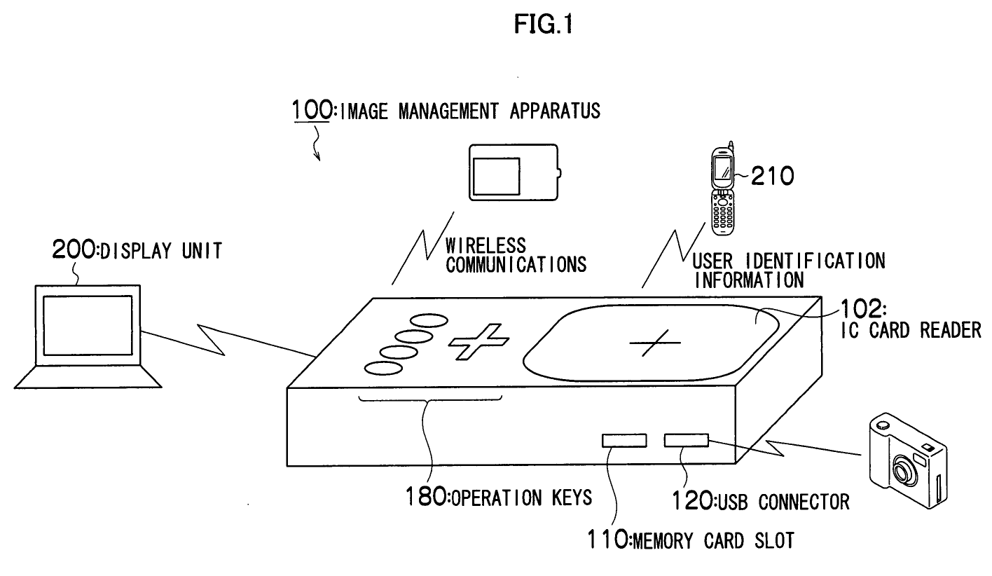

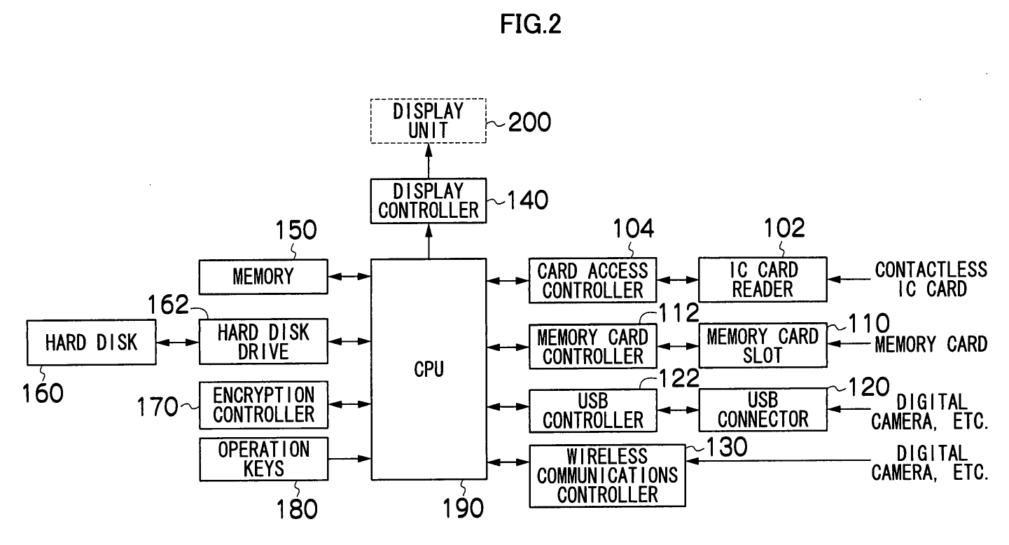

FIG. 1 is an external view of an image management apparatus according to an embodiment of the present invention. FIG. 2 is a block diagram showing an internal configuration of an image management apparatus 100.

As shown in FIGS. 1 and 2, the image management apparatus 100 is shared, for example, by family members and manages private images of each member. It comprises an IC card reader 102, a card access controller 104, a memory card reader/writer including a memory card slot 110 and memory card controller 112, a wired communications device including a USB connector 120 and USB controller 122, a wireless communications controller 130 for radio or infrared communications, a display controller 140 which makes a display unit 200 display images, a memory 150, a hard disk 160, a hard disk drive 162, an encryption controller 170, operation keys 180, and a central processing unit (CPU) 190 which totally controls various parts in the apparatus.

The IC card reader 102 is controlled by the card access controller 104. It contactlessly reads user identification information from a contactless IC card and outputs it to the CPU 190. The IC card reader 102 has a communications range (e.g., several 10 cm or less) which does not support communications with (scanning of) anything other than a contactless IC card in its vicinity. The contactless IC card may be, for example, Suica (trademark) of JR East, FeliCa (trademark) developed by Sony Corp., an employee card, or the like. Besides, it may be a contactless IC card embedded in a cell phone and used as electronic money. FIG. 1 shows how user identification information is read from a contactless IC card embedded in a cell phone 210.

The memory card reader/writer reads and writes images from/into a memory card inserted in the memory card slot 110. The wired communications device captures images by communicating with an apparatus (such as digital camera, camera-equipped cell phone, personal digital assistant (PDA), or mobile personal computer which has images) connected to the USB connector 120. A wireless communications device captures images through wireless communications with an apparatus which has images. Incidentally, available wireless communications devices include UWB wireless communications devices, Bluetooth-compliant wireless communications devices, and IrDa-compliant infrared communications devices.

The memory 150 stores firmware and user management information of the image management apparatus. The hard disk 160 driven by the hard disk drive 162 stores users' images.

The encryption controller 170 includes a generating device which generates a cryptographic key and decryption key based on the user identification information read from the contactless IC card. It encrypts users' images to be stored in the hard disk 160 using the generated cryptographic key and decrypts encrypted images read out of the hard disk 160 using the decryption key. Incidentally, a cryptosystem according to the encryption controller 170 can use either of a public-key cryptosystem and secret-key cryptosystem, but this embodiment employs a cryptographic system in which the cryptographic key and decryption key are identical and both of them are secret keys.

The operation keys 180 include a power switch and a button group used to play back and edit images, and so on. In response to manipulation of operation keys 180, the CPU 190 reads a desired image out of the hard disk 160 by the operation input and displays it on the display unit 200 via the display controller 140 or outputs it to a printer (not shown).

Next, description will be given of how images are captured into the image management apparatus 100.

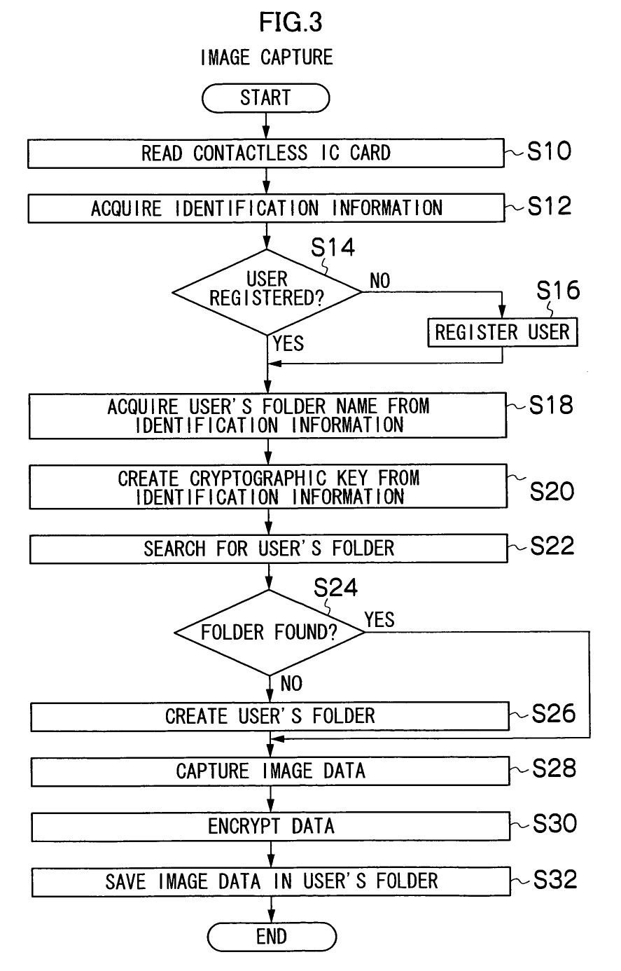

Referring to FIG. 3, to capture user's images into the image management apparatus 100, the user turns on the image management apparatus 100 and brings his/her contactless IC card (or a cell phone with a built-in contactless IC card) close to the IC card reader 102, allowing the latter to read the user identification information contained in the contactless IC card (Step S10).

The CPU 190 of the image management apparatus 100 acquires the user identification information from the contactless IC card via the IC card reader 102 and card access controller 104 (Step S12).

The CPU 190 determines whether the user identification information has already been registered (Step S14) and registers it if it is yet to be registered (Step S16).

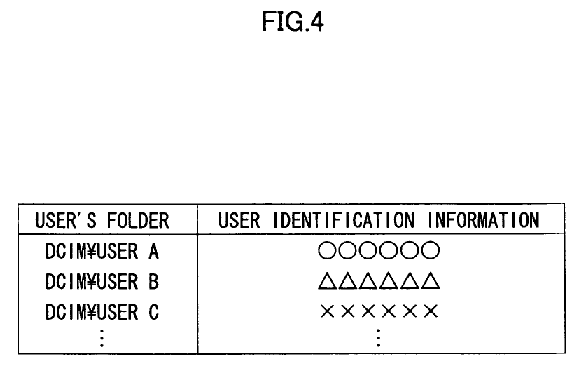

The user registration process in Step S16 involves registering the user identification information acquired from the contactless IC card in a user management table by associating it with a folder name for exclusive use by the user as shown in FIG. 4.

If the user has already been registered or if the user is registered in Step S16, the CPU 190 acquires the appropriate user's folder name from the user identification information (Step S18).

Subsequently, the CPU 190 outputs the user identification information acquired from the contactless IC card to the encryption controller 170, which generates a cryptographic key from the user identification information (Step S20). Also, the CPU 190 searches the hard disk 160 for a folder corresponding to the user's folder name acquired in Step S18 (Step S22).

If it is determined in Step S24 that a folder corresponding to the user's folder name exists on the hard disk 160, the CPU 190 goes to Step S28 to capture image data. If it is determined that no folder corresponding to the user's folder name exists on the hard disk 160, the CPU 190 creates a folder corresponding to the user's folder name on the hard disk 160 (Step S26) and then goes to Step S28.

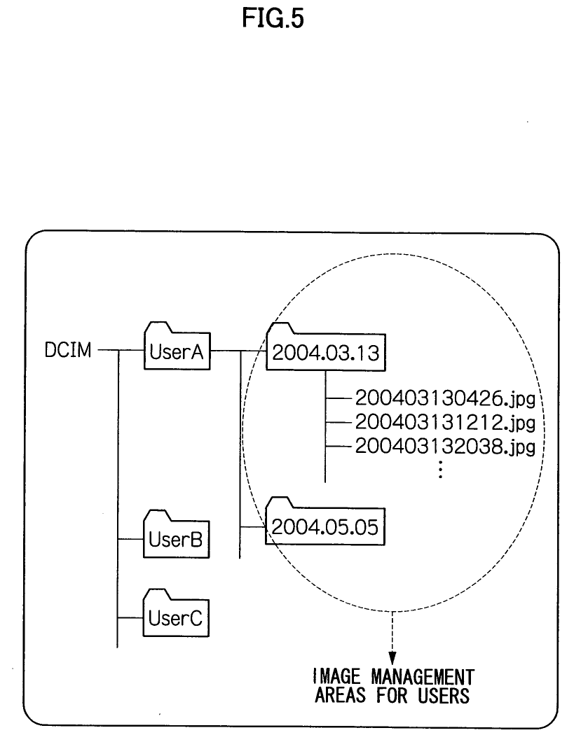

In Step S26, a folder unique to the user and corresponding to the user's folder name acquired in Step S18 is 190 generated on the hard disk 160. That is, a folder with a tree structure shown in FIG. 5 is generated.

In Step S28, the user's images are captured via a memory card reader/writer, USB communications device, or wireless communications device. The captured user's image data are encrypted using the cryptographic key generated in Step S20 (Step S30) and saved in the user's folder corresponding to the user identification information (Step S32).

That is, when saving image data in the image management apparatus 100, the user identification information of the user's contactless IC card is read via the IC card reader 102, and then the user's image data are read from the digital camera or memory card and saved in encrypted form in the user's folder unique to the user.

Incidentally, when saving image data in the user's folder, the folder is divided according to shooting dates as shown in FIG. 5 to make it easier for the user to view the images. Shooting dates recorded in headers of image files can be used for this purpose.

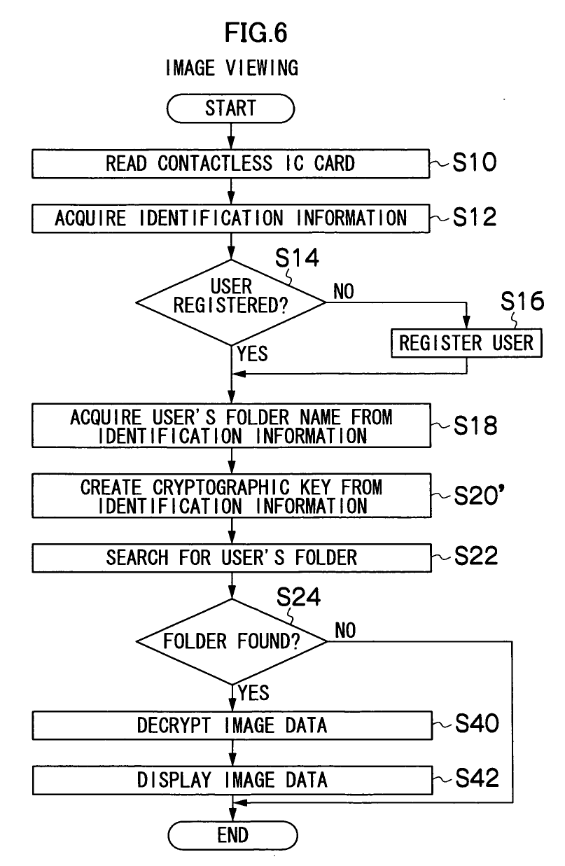

Next, description will be given of procedures for viewing images saved in the image management apparatus 100, using FIG. 6. Steps in common with the flowchart in FIG. 3 will be designated by the same step numbers, and description thereof will be omitted.

The image management apparatus 100 reads the user identification information from the contactless IC card owned by the user using the IC card reader 102 as in the case of image capture, and allows the user to view the images.

That is, in Step S20′, a decryption key is generated from the user identification information. Incidentally, according to this embodiment, since the cryptographic key and decryption key are identical, the process in Step S20′ is identical to the process in Step S20 in FIG. 3.

The CPU 190 searches the hard disk 160 for a folder of a folder name corresponding to the user identification information read from the contactless IC card. If a folder exists, the CPU 190 reads image data out of the folder and decrypts them using the decryption key generated in Step S20′ (Step S40). The decrypted image data are outputted to the display unit 200 which displays them (Step S42).

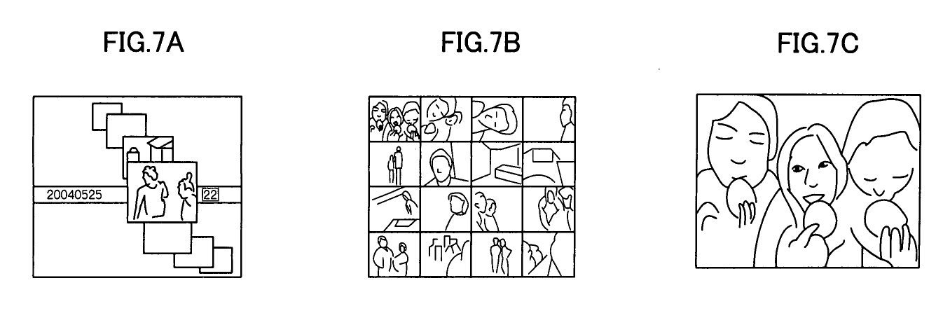

Incidentally, to display a desired image on the display unit 200, the user displays sub-folders of the user's folder classified according to shooting dates as shown in FIG. 7A. A representative image (e.g., the first image in the sub-folder) is shown on each sub-folder, and the shooting date is shown on the selected sub-folder.

When the user selects and opens a desired sub-folder from among the sub-folders in the user's folder classified by shooting dates, index images (thumbnail images) of the images in the selected sub-folder are listed as shown in FIG. 7B. The user can display a desired image as shown in FIG. 7C by selecting it from the index images and specifying zoom-in. Incidentally, to display the desired image, operation keys 180 and a screen of the display unit 200 can be used. Also, operation keys 180 can be used for frame advance and automatic playback (slide show).

Although according to this embodiment, the image capture process and image viewing process have been described separately with reference to the flowcharts in FIGS. 3 and 6, respectively, these processes can be performed concurrently. Specifically, when the user identification information is read from the contactless IC card, if a user's folder exists, images in the folder become available for viewing, and while images are displayed, images are captured automatically in the background at the same time if a digital camera or the like is connected to the image management apparatus 100 and ready to capture images.

By reading the user identification information from the contactless IC card, the image management apparatus 100 allows the user to login the user's folder corresponding to the user identification information and manipulate the images in the user's folder freely until logout and power-off. Also, the user is allowed to modify the user identification information.

Also, a digital camera can be configured by combining the image management apparatus 100 according to this embodiment with an image pickup device which picks up and captures images. In that case, user identification information recorded on a contactless IC card can be read by the digital camera and images captured by the image pickup device can be stored in a user's folder corresponding to the user identification information. Even when the digital camera configured in this way is shared by multiple people, the users can prevent images they shot from being viewed by others.

The images saved in the image management apparatus 100 are not limited to still images, and may be moving images.

What is claimed is:

1. An image management apparatus, comprising:
an image capture device which captures images;
an image saving device which saves the images;
a user identification information reading device which contactlessly reads user identification information from a contactless IC card containing the user identification information unique to a given user;
a folder creating device which automatically creates in the image saving device an image folder unique to the user when the user identification information reading device reads user identification information and if there is no image folder unique to the user corresponding to the read user identification information;
an image storage control device which stores any image captured via the image capture device in the image folder corresponding to the read user identification information after the user identification information is read by the user identification information reading device; and
an image output control device which makes any image stored in the image folder corresponding to the read user identification information ready for output when the user identification information is read by the user identification information reading device.

2. The image management apparatus according to claim 1, wherein the image capture device comprises at least one of a communications device which captures images by wire or radio, an image reading device which reads images from a recording medium containing images, and an image pickup device which picks up and captures images.

3. The image management apparatus according to claim 1, wherein the contactless IC card can be a contactless IC card incorporated in a user's portable apparatus.

4. The image management apparatus according to claim 1, further comprising: a cryptographic key generating device which generates a cryptographic key from the user identification information read by the user identification information reading device, wherein the image storage control device encrypts the images captured via the image capture device based on the cryptographic key generated by the cryptographic key generating device and stores the encrypted images in the appropriate image folder.

5. The image management apparatus according to claim 4, further comprising: a decryption key generating device which generates a decryption key from the user identification information read by the user identification information reading device, wherein the image output control device decrypts the encrypted images stored in the image folder corresponding to the user identification information based on the decryption key generated by the decryption key generating device and makes the decrypted images ready for output.

6. An image management method, comprising the steps of:
contactlessly reading user identification information from a contactless IC card containing the user identification information unique to a given user;
determining whether an image folder unique to the user corresponding to the read user identification information exists in an image saving device and automatically creating an image folder unique to the user corresponding to the user identification information if no such image folder exists;
storing images captured via an image capture device in the image folder unique to the user corresponding to the read user identification information when storing the captured images in the image saving device; and
outputting images from the image folder unique to the user corresponding to the read user identification information when outputting saved images from the image saving device.

7. The image management method according to claim 6, wherein in the step of storing captured images in the image folder unique to the user corresponding to the read user identification information a cryptographic key based on the read user identification information is created and the image is stored after encrypting the image based on the cryptographic key.

8. The image management method according to claim 7, wherein in the step of outputting images from the image folder a decryption key based on the read user identification information read by the user identification information reading device is generated, the encrypted images stored in the image folder based on the decryption key is decrypted, and the decrypted image is outputted.
